(19) United States
(12) Patent Application Publication
(10) Pub. No.: US 2016/0010595 A1
(43) Pub. Date: Jan. 14, 2016

(54) Device for Recirculating Exhaust Gas from the Engine of an Automobile, and Use of Such a Device

(71) Applicant: Valeo Systemes Thermiques, Le Mesnil Saint Denis (FR)

(72) Inventors: Guillaume Bourgoin, Limoges (FR); Bertrand Gessier, Montfort L'Amaury (FR)

(21) Appl. No.: 14/805,182

(22) Filed: Jul. 21, 2015

Related U.S. Application Data
(62) Division of application No. 13/807,428, filed on Jul. 22, 2013.

(30) Foreign Application Priority Data
Jun. 30, 2010 (FR) FR 1002778

(51) Int. Cl. F02M 25/07

(52) U.S. Cl. CPC F02M 25/074

(57) ABSTRACT

The invention concerns a device for recirculation of exhaust gases from an engine (1) of a motor vehicle, comprising a first exhaust gas recirculation line (9) called an EGR line, a first heat exchanger (10) provided on said EGR line (9) to ensure cooling of the recirculated exhaust gases, and treatment means (11) for the exhaust gases allowing limitation of the pH of the condensate arising from said gases. The treatment means (11) are provided upstream of the first exchanger (10) along the path of the exhaust gases, and the exchanger (10) comprises a heat exchanger bundle made of aluminum and/or aluminum alloy.

The present invention concerns a device for recirculation of exhaust gases from an engine of a motor vehicle. It is used in particular in diesel engines.

At present, to reduce polluting emissions, it is known to extract part of the exhaust gas from the engine and reinject this into the engine air intake circuit. This is usually called EGR (exhaust gas recirculation). To ensure correct filling of the cylinders and to protect the elements of the intake line, the recirculated gas is cooled using exchangers, known as EGR exchangers.

Because of the high proportion of water contained in the recirculated gas, condensation phenomena occur in the EGR exchangers. This condensation is by nature often acidic and aggressive, in particular because of the dissolution of hydrocarbons unburned by the engine and evacuated into the exhaust line. The result is an acid attack on components of the exchanger in contact with the condensate.

It is also noted that this acidity is higher in exhaust gas recirculation lines where, along these lines, the recirculated gases are not yet mixed with other gases, as they will be in the remainder of their journey towards the engine where they will be mixed with exterior air, generating more alkaline condensate.

To limit the risk relating to the acidity of condensate liable to occur in EGR exchangers, it is generally considered necessary to use EGR exchangers of stainless steel. They can also be made of cast aluminum with high material thickness. These solutions limit the performance, in particular the thermal performance, of the exchangers and increase their costs.

The invention proposes to remedy said drawbacks and its object is a device for recirculation of exhaust gases from an engine of a motor vehicle, comprising a first exhaust gas recirculation line called an EGR line, a first heat exchanger provided on said EGR line to ensure cooling of the recirculated exhaust gases, and treatment means for the exhaust gases allowing limitation of the pH of the condensate arising from said gases.

According to the invention, such treatment means are provided upstream of said first exchanger along the path of the exhaust gases and said exchanger comprises a heat exchanger bundle made of aluminum and/or aluminum alloy.

By providing such a treatment device, it is noted that the acidity of the condensate liable to occur in the EGR exchangers is reduced before the exhaust gases pass through said exchangers. It is thus possible to provide EGR exchangers in which the components no longer require such high performance against corrosion as before. They can therefore be optimized in terms of thermal performance and have a lower cost.

According to various embodiments of the invention:

said bundle comprises components of aluminum and/or aluminum alloy obtained by rolling,

said treatment means for the exhaust gases comprise an oxidation catalyst for the exhaust gases,

said engine comprises an engine exhaust line, and said exhaust line comprises a turbine able to be driven by said exhaust gases, said first EGR line is able to communicate with said exhaust line upstream of said turbine, said treatment means being located along said first EGR line,

said engine comprises an exhaust line, and said exhaust line comprises a turbine able to be driven by said exhaust gases, said first EGR line is provided so as to be able to communicate with said exhaust line downstream of said turbine, said treatment means being provided so as to be able to be located along said exhaust line, in particular downstream of said turbine,

said device also comprises a second exhaust gas recirculation line, said second EGR line being able to communicate with said exhaust line upstream of said turbine,

said device comprises a second heat exchanger provided on said second EGR line to cool the recirculated exhaust gases passing into said second line,

said second exchanger comprises a heat exchanger bundle made of stainless steel,

said treatment means are also provided along said second EGR line upstream of said exchanger, and said second exchanger comprises a heat exchanger bundle made of aluminum and/or aluminum alloy.

The invention also concerns the use of the device as described above with fuels of vegetable origin, standard European diesel and/or fuels from gas and/or coal. It has in fact been found that with these fuels, the reduction in the acidity of condensate obtained using the device according to the invention is all the more effective.

The invention will be better understood in the light of the description below which is given merely for information, without being intended as restrictive, accompanied by the attached drawings in which:

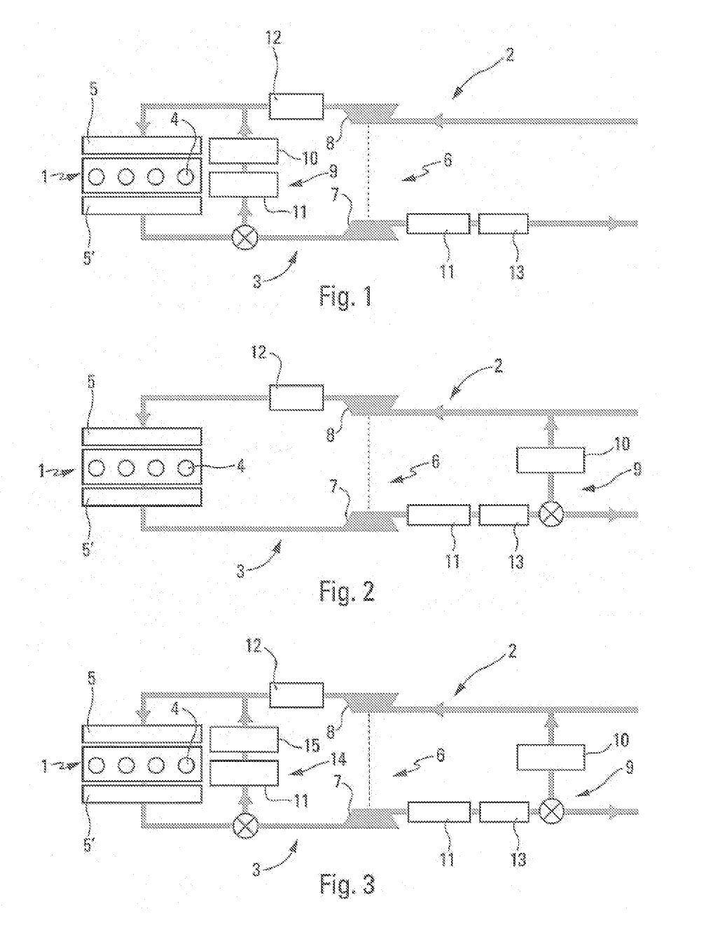

FIG. 1 illustrates diagrammatically a first exemplary embodiment of the device according to the invention,

FIG. 2 illustrates diagrammatically a second exemplary embodiment of the device according to the invention,

FIG. 3 illustrates diagrammatically a third exemplary embodiment of the device according to the invention.

As shown in the various figures, the invention is applied for example to an engine 1 of a vehicle with an air intake line 2 and/or an exhaust line 3. The intake line 2 allows the engine to be supplied with intake air, in particular fresh air. The exhaust line 3 allows evacuation of the exhaust gases generated by the combustion which took place in the combustion chambers 4 of the engine, by reaction of the intake air with the fuel introduced into the chambers.

The engine comprises for example an intake manifold 5 distributing the intake air from the intake line 2 into the combustion chambers 4, and an exhaust manifold 5′ collecting the exhaust gases from the combustion chambers 4 to direct them towards the exhaust line 3.

A turbocompressor 6 can also be provided which allows compression of the intake air by the kinetic energy of the exhaust gases passing through the exhaust line 3. Said turbocompressor comprises for example a turbine 7 able to be driven by said exhaust gases and/or a compressor 8 driven by said turbine 7 and intended to compress the intake air passing through the intake line 2. The turbine 7 is thus provided at the level of the exhaust line 3 and the compressor 8 is provided at the level of the intake line 2, the turbine 7 and the compressor 8 being mechanically linked together so that the compressor 8 is driven by the turbine 7.

The intake line 2 can comprise a supercharging air cooler 12 allowing cooling of the charge air which passes through it before being introduced into the engine 1. Said charge air cooler 12 is provided downstream of the compressor 8.

The exhaust line 3 can comprise a particle filter 13 allowing a reduction in the polluting emissions from the exhaust gases. Said particle filter 13 is provided downstream of the turbine 7.

The device according to the invention comprises a first exhaust gas recirculation line 9 called an EGR line, and a first heat exchanger 10 provided on said EGR line to ensure cooling of the recirculated exhaust gases. Said EGR line opens at the level of the intake line 2. The flow of recirculated exhaust gases and/or intake air is ensured via various valves.

Said heat exchanger 10 is for example an exchanger, known as water exchanger, allowing the exchange of heat between a cooling liquid, in particular water with glycol from the vehicle cooling circuit, and the exhaust gases. For this, the exchanger comprises a heat exchanger bundle, not shown in detail, defining a first circuit for the cooling liquid and a second circuit for the recirculated exhaust gases, said first and second circuits having a thermal exchange connection. The term heat exchanger bundle signifies in particular all components of the bundle in contact with the exhaust gases passing through the exchanger.

The device according to the invention furthermore comprises treatment means 11 for the exhaust gases allowing limitation of the pH of the condensate arising from said gas.

According to the invention, said treatment means 11 are provided upstream of said first exchanger 10 along the path of the exhaust gases, and the heat exchanger bundle of said exchanger is made of aluminum and/or aluminum alloy. In fact by providing such treatment means downstream, it is no longer necessary to use components of stainless steel for the exchanger. Therefore aluminum can be used which helps achieve an improved thermal performance and a reduction in cost.

Thus components of aluminum and/or aluminum alloy could be used which are obtained by rolling. The exchanger bundle could therefore comprise plates made of such material, said plates being stacked to define exhaust gas circulation panels alternating with cooling liquid circulation panels.

The treatment means 11 for the exhaust gases comprise for example an exhaust gas oxidation catalyst, also called a two-way catalyst. Such a catalyst allows oxidation of the unburned hydrocarbons into carbon dioxide and water.

According to a first embodiment shown in FIG. 1, said first EGR line 9 is provided so as to be able to communicate with said exhaust line 3 upstream of said compressor 7. Said treatment means 11 are then located for example along said first EGR line 9. In this embodiment, the EGR line opens into the intake line 2, for example downstream of compressor 8 or the charge air cooler 12.

According to other embodiments corresponding to those of FIGS. 2 and 3, said first EGR line 9 is provided so as to be able to communicate with said exhaust line 3 downstream of said turbine 7 or the particle filter 13. Said treatment means 11 are then located for example along said exhaust line 3, in particular downstream of said turbine 7, for example upstream of the particle filter 13. In such a configuration, the three-way catalyst therefore processes the entirety of the exhaust gases which have passed through the turbine 7.

The EGR line 9 opens into said intake line, for example upstream of the compressor 8.

According to a first variant corresponding to the embodiment in FIG. 2, no other EGR line is provided.

According to other variants a second exhaust gas recirculation line 14 can be provided. Said second EGR line is provided able to communicate with the exhaust line 3 upstream of said turbine 7. A second heat exchanger 15 is provided on said second EGR line 14 to cool the recirculated exhaust gases passing into said second line 14. The latter opens into the intake line, for example downstream of the compressor 8 or the charge air cooler 12.

According to a first exemplary embodiment, not shown, said second exchanger 15 comprises a heat exchanger bundle made of stainless steel.

According to a second exemplary embodiment corresponding to FIG. 3, treatment means 11, in particular a second two-way catalyst, are also provided along said second EGR line 14 upstream of said second exchanger 15. Said exchanger 15 then comprises a heat exchanger bundle made of aluminum and/or aluminum alloy.

The invention furthermore concerns the use of the device as described above with fuels of vegetable origin, in particular fuel based on soya oil, palm oil or rapeseed oil, or fuels from biomass. The fuel could also be standard European diesel, in particular diesel with 10 ppmS, or fuels from gas or coal.

1. A device for recirculating exhaust gases from an engine of a motor vehicle, comprising a first exhaust gas recirculation line called an EGR line, a first heat exchanger provided on said EGR line to ensure cooling of the recirculated exhaust gases, and treatment means for the exhaust gases allowing limitation of the pH of the condensate arising from said gases, said treatment means being provided upstream of said first exchanger along the path of the exhaust gases and said exchanger comprising a heat exchanger bundle made of aluminum and/or aluminum alloy;
wherein said engine comprises an exhaust line and said exhaust line comprises a turbine able to be driven by said exhaust gases, said first EGR line is provided so as to be able to communicate with said exhaust line downstream of said turbine, said treatment means being provided so as to be able to be located along said exhaust line.

2. The device as claimed in claim 1, wherein said bundle comprises components of aluminum and/or aluminum alloy obtained by rolling.

3. The device as claimed in claim 1, wherein the treatment means for the exhaust gases comprise an oxidation catalyst for the exhaust gases.

4. (canceled)

5. (canceled)

6. The device as claimed in claim 1, also comprising a second exhaust gas recirculation line, said second EGR line being able to communicate with the exhaust line upstream of said turbine and comprising a second heat exchanger to cool the recirculated exhaust gases passing into said second EGR line.

7. The device as claimed in claim 6, wherein said second exchanger comprises a heat exchanger bundle made of stainless steel.

8. The device as claimed in claim 6, wherein said treatment means are also provided along said second EGR line upstream of said second exchanger, and said second exchanger comprises a heat exchanger bundle made of aluminum and/or aluminum alloy.

9. A method of using the deice as claimed in claim 1 comprising using the device with fuels of vegetable origin.

10. A method of using the device as claimed in claim 1 comprising using the device with standard European diesel and/or fuels from gas and/or coal.

11. The device as claimed in claim 2, wherein the treatment means for the exhaust gases comprise an oxidation catalyst for the exhaust gases.
